(19) United States
(12) Patent Application Publication
(10) Pub. No.: US 2023/0122484 A1
(43) Pub. Date: Apr. 20, 2023

(54) Powerline De-icing Device

(71) Applicant: Dennis Gladney, Houston, MS (US)

(72) Inventor: Dennis Gladney, Houston, MS (US)

(21) Appl. No.: 17/859,203

(22) Filed: Jul. 7, 2022

Related U.S. Application Data
(60) Provisional application No. 63/256,797, filed on Oct. 18, 2021.

(51) Int. Cl. H02G 7/16; H01M 10/46

(52) U.S. Cl. CPC H02G 7/16; H01M 10/465

(57) ABSTRACT

The present invention relates to a powerline de-icing device primarily comprised of a body, further comprised of at least one solar panel, at least one battery, at least one heating element, and at least one heat-able wire. In the preferred embodiment, the device is comprised of a solar panel that supplies power to the battery, wherein the battery supplies power to the heating element which provides an electrical charge to the wire and in turn heats the wire. The wire can then be wrapped and secured around a power line to prevent ice and snow from forming on the power line. Furthermore, the device may be comprised of a temperature sensor that automatically activates the heating element when the ambient temperature around the device is below a threshold temperature (e.g., 32 degrees Fahrenheit).

### CROSS-REFERENCE TO RELATED APPLICATION

The present application claims priority to, and the benefit of, U.S. Provisional Application No. 63/256,797, which was filed on Oct. 18, 2021, and is incorporated herein by reference in its entirety.

### FIELD OF THE INVENTION

The present invention relates generally to the field of de-icing devices. More specifically, the present invention relates to a powerline de-icing device primarily comprised of a body, further comprised of at least one solar panel, at least one battery, at least one heating element, and at least one heat-able wire. In the preferred embodiment, the device is comprised of a solar panel that supplies power to the battery, wherein the battery supplies power to the heating element which provides an electrical charge to the wire and in turn, heats the wire. The wire can then be wrapped and secured around a power line to prevent ice and snow from forming on the power line. Furthermore, the device may be comprised of a temperature sensor that automatically activates the heating element when the ambient temperature around the device is below a threshold temperature (e.g., 32 degrees Fahrenheit). Accordingly, the present disclosure makes specific reference thereto. Nonetheless, it is to be appreciated that aspects of the present invention are also equally applicable to other like applications, devices and methods of manufacture.

### BACKGROUND

Inclement weather during the winter months can lead to significant snow and ice buildup on power lines. Without a way to clear the lines, the lines can break and as a result, thousands of individuals may lose power for a prolonged period of time. Losing electricity during a winter storm can cause significant problems and challenges for a community, even if power is only down for a short amount of time.

Therefore, there exists a long-felt need in the art for a powerline de-icing device. There also exists a long-felt need in the art for a powerline de-icing device that automatically ensures snow and ice does not form on powerlines during the winter months. Further, there exists a long-felt need in the art for a powerline de-icing device that requires no user input to function once installed.

The subject matter disclosed and claimed herein, in one embodiment thereof, comprises a powerline de-icing device. The device is primarily comprised of a body, further comprised of at least one solar panel, at least one battery, at least one heating element, and at least one heat-able wire. In the preferred embodiment, the device is comprised of a solar panel that supplies power to the battery. The battery supplies power to the heating element which provides an electrical charge to the wire which in turn, heats the wire. The wire can then be wrapped and secured around a power line to prevent ice and snow from forming on the power line. The device may also be comprised of a temperature sensor that automatically activates the heating element when the ambient temperature around the device is below a threshold temperature (e.g., 32 degrees Fahrenheit).

In this manner, the powerline de-icing device of the present invention accomplishes all of the foregoing objectives and provides a device that can de-ice power lines. The powerline de-icing device further automatically ensures snow and ice does not form on powerlines during the winter months. In addition, the device requires no user input to function once installed.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a powerline de-icing device. The device is primarily comprised of a body, further comprised of at least one solar panel, at least one battery, at least one heating element, and at least one heat-able wire. The body is preferably comprised of a durable metal, such as but not limited to, stainless steel or aluminum that is preferably corrosion resistant to withstand snow, ice, rain, etc. The bottom surface of the body is preferably comprised of at least one strap with least one opening that allows at least one fastener to be used to secure the strap to a power line pole.

The heating element is located within the body and is powered by the battery. The heating element provides an electrical current through the wire, which is secured to the heating element through at least one opening in at least one of the side surfaces of the body using at least one tab and at least one fastener such as, but not limited to, a bolt. In this manner, the wire can be wrapped around a power line such that the wire continuously heats the surface of the power line while receiving electrical current from the heating element. The wire can be secured to the power line via at least one strap.

The battery may be charged via at least one solar panel. In one embodiment, the solar panel may be of a fixed position. In a differing embodiment, the solar panel is repositionable about at least one hinge point of at least one mounting arm that is attached to the top surface of the body. In this manner, the solar panel supplies a constant charge to the battery to power the heating element and ensure the wire remains heated.

An embodiment of the device may also have at least one temperature sensor which automatically activates the heating element when the ambient temperature around the device is at or below 32 degrees Fahrenheit (freezing). In this manner, the wire will automatically be heated when the temperature is at or below freezing, therefore ensuring ice and snow does not collect on the power line.

Accordingly, the powerline de-icing device of the present invention is particularly advantageous as it provides a device that can de-ice power lines. In doing so, the powerline de-icing device automatically ensures snow and ice does not form on powerlines during the winter months. In addition, the device requires no user input to function once installed. In this manner, the powerline de-icing device provides a novel means of preventing snow and ice from forming on power lines during winter months.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a powerline de-icing device of the present invention while attached to a power line pole in accordance with the disclosed architecture;

FIG. 2 illustrates an enhanced perspective view of the solar panel and body of one potential embodiment of a powerline de-icing device of the present invention while attached to a power line pole in accordance with the disclosed architecture;

FIG. 3 illustrates a perspective view of one potential embodiment of a powerline de-icing device of the present invention while attached to a power line pole and a power line in accordance with the disclosed architecture; and

FIG. 4 illustrates a flow chart of one potential method of using one potential embodiment of a powerline de-icing device of the present invention while attached to a power line pole in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a powerline de-icing device. There also exists a long-felt need in the art for a powerline de-icing device that automatically ensures snow and ice does not form on powerlines during the winter months. Further, there exists a long-felt need in the art for a powerline de-icing device that requires no user input to function once installed.

The present invention, in one exemplary embodiment, is comprised of a powerline de-icing device primarily comprised of a body, further comprised of at least one solar panel, at least one battery, at least one heating element, and at least one heat-able wire. The body is preferably comprised of a durable metal, such as but not limited to, stainless steel or aluminum that is preferably corrosion resistant to withstand snow, ice, rain, etc. The bottom surface of the body is preferably comprised of at least one strap with least one opening that allows at least one fastener to be used to secure the strap to a power line pole.

The heating element is located within the body and is powered by the battery. The heating element provides an electrical current through the wire, which is secured to the heating element through at least one opening in at least one of the side surfaces of the body via at least one tab and at least one fastener, such as but not limited to, a bolt. As a result, the wire can be wrapped around a power line such that the wire continuously heats the surface of the power line while receiving electrical current from the heating element. The wire can be secured to the power line via at least one strap.

The battery may be charged via at least one solar panel. The solar panel may be of a fixed position or may be repositionable about at least one hinge point of at least one mounting arm that is attached to the top surface of the body. In this manner, the solar panel supplies a constant charge to the battery to power the heating element and ensure the wire remains heated.

Furthermore, an embodiment of the device may also have at least one temperature sensor which automatically activates the heating element when the ambient temperature around the device is at or below 32 degrees Fahrenheit (freezing). In this manner, the wire will automatically be heated when the temperature is at or below freezing, therefore ensuring ice and snow does not collect on the power line.

Accordingly, the powerline de-icing device of the present invention is particularly advantageous as it provides a device that can de-ice power lines. The powerline de-icing device that automatically ensures snow and ice does not form on powerlines during the winter months. In addition, the device requires no user input to function once installed. In this manner, the powerline de-icing device provides a novel means of preventing snow and ice from forming on power lines during winter months.

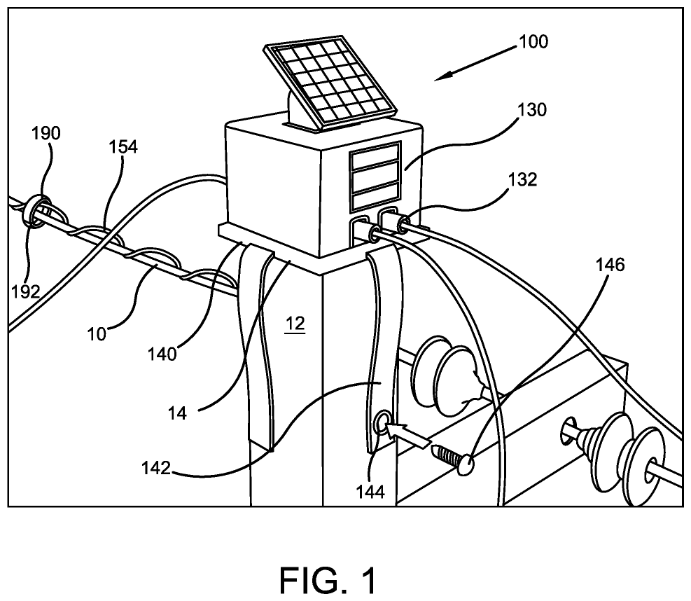

Referring initially to the drawings, FIG. 1 illustrates a perspective view of one potential embodiment of a powerline de-icing device 100 of the present invention while attached to a power line pole in accordance with the disclosed architecture. The device 100 is primarily comprised of a body 110, further comprised of at least one solar panel 122, at least one battery 160, at least one heating element 150, and at least one heat-able wire 154. The body 110 is preferably manufactured from a durable metal, such as but not limited to, stainless steel or aluminum that is preferably corrosion resistant to withstand snow, ice, rain, etc. The body 110 is preferably square in shape but may be any other shape without limitation, such as but not limited to: cylindrical, circular, rectangular, etc.

The bottom surface 140 of the body 110 is preferably comprised of at least one strap 142. The strap 142 may be manufactured from a durable fabric, weather-resistant material. The strap 142 has at least one opening 144, which in one embodiment may be a metal grommet, which allows at least one fastener 146, such as but not limited to: a nail, a screw, etc. to be used to secure the strap 142 to a power line pole 12. The device 100 is preferably positioned on the top surface 14 of the pole 12 but may be adapted to be mounted to differing locations of the pole 12 in differing embodiments.

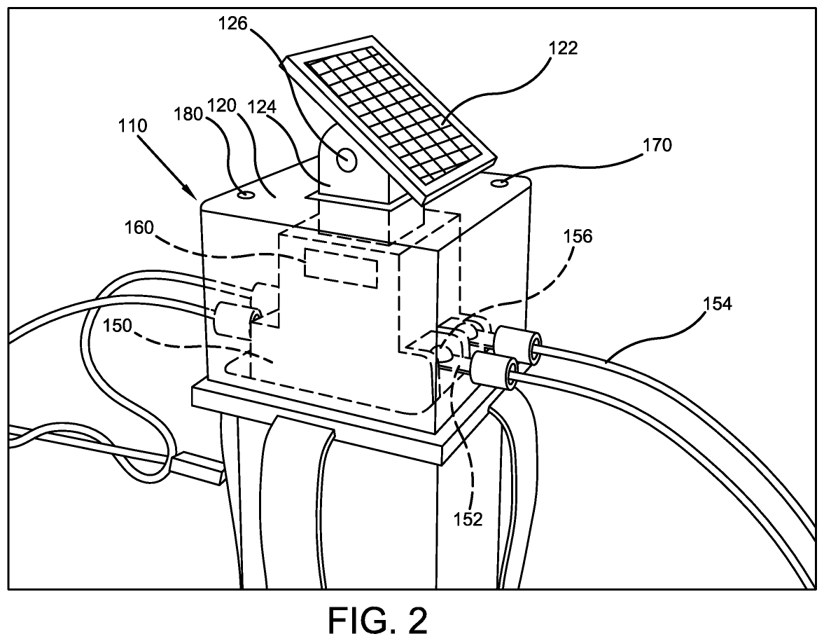

As seen in FIG. 2, the heating element 150 is located within the body 110. The heating element 150 is powered by the battery 160. The battery 160 may be a disposable battery 160 or a rechargeable battery 160 in the form of an alkaline, nickel-cadmium, nickel-metal hydride battery 160, etc., such as any 3V-12 volt DC battery 160 or other conventional battery 160, such as A, AA, AAA, etc., that supplies power to the device 100. Throughout this specification the terms “battery” and “batteries” may be used interchangeably to refer to one or more wet or dry cells, or batteries 160 of cells in which chemical energy is converted into electricity and used as a source of DC power. References to recharging or replacing batteries 160 may refer to recharging or replacing individual cells, individual batteries 160 of cells, or a package of multiple battery cells as is appropriate for any given battery 160 technology that may be used.

The heating element 150 provides an electrical current through the wire 154, which is secured to the heating element 150 through at least one opening 132 in at least one of the side surfaces 130 of the body 110 using at least one tab 152 (that is preferably metal for electricity conducting purposes) and at least one fastener 156, such as but not limited to, a bolt. In this manner, the wire 154 can be wrapped around a power line 10 such that the wire 154 continuously heats the surface of the power line 10 while receiving an electrical current from the heating element 150.

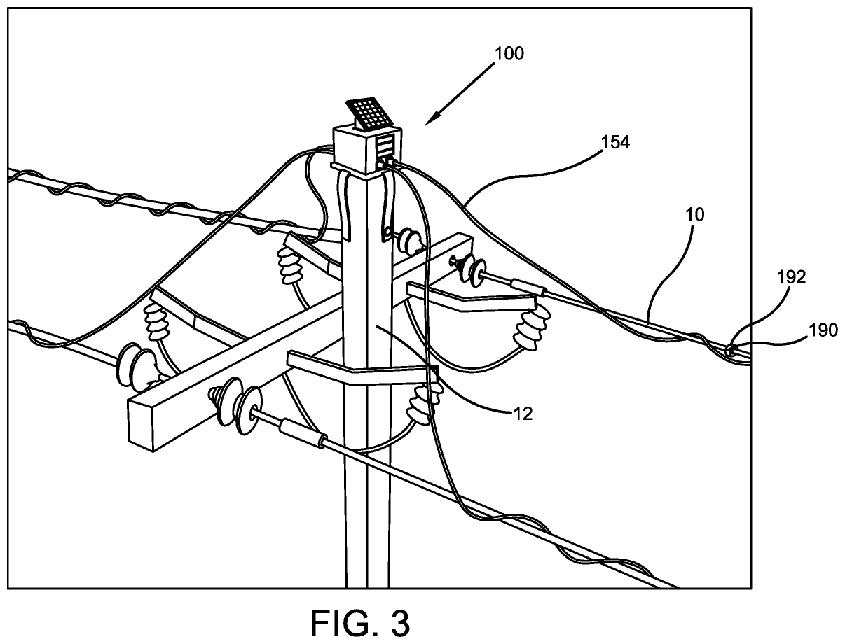

FIG. 3 illustrates a perspective view of one potential embodiment of a powerline de-icing device 100 of the present invention while attached to a power line pole 12 and a power line 10 in accordance with the disclosed architecture. In one embodiment, one wire 154 may be wrapped above the power line 10 and one wire 154 may be wrapped below the power line 10. The wire 154 can be secured to the power line 10 via at least one strap 190. The strap 190 may further have at least one fastener 192, such as but not limited to: a buckle, a tie, elastic, a zipper, etc. that allows it to remain in a secured position.

The battery 160 may be charged via at least one solar panel 122. In the preferred embodiment, the solar panel 122 is located on the top surface 120 of the body 110. Although, in differing embodiments, the solar panel 122 may be located anywhere on the body 110 or at a separate location from the body 110 (while still remaining in electrical communication with the battery 160). In one embodiment, the solar panel 122 may be of a fixed position. In a differing embodiment, the solar panel 122 is repositionable about at least one hinge point 126 of at least one mounting arm 124 that is attached to the top surface 120. In this manner, the solar panel 122 supplies a constant charge to the battery 160 to power the heating element 150 and ensure the wire 154 remains heated.

In one embodiment, the device 100 is comprised of at least one temperature sensor 170. The temperature sensor 170 automatically activates the heating element 150 when the ambient temperature around the device 100 is at or below 32 degrees Fahrenheit (freezing) or below a chosen threshold temperature. In this manner, the wire 154 will automatically be heated when the temperature is at or below freezing, therefore ensuring ice and snow does not collect on the power line 10. The addition, the temperature sensor 170 further ensures the device 100 need not be manually activated. Although, the heating element 150 and/or device 100 may be manually activated via at least one button 180 in one embodiment.

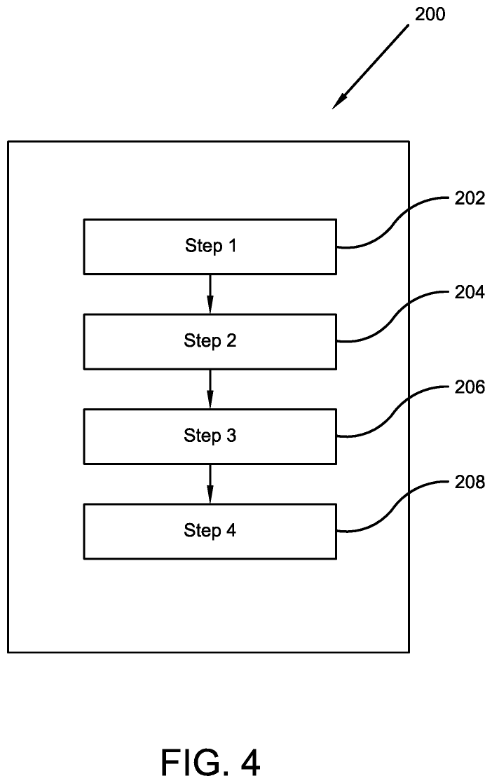

FIG. 4 illustrates a flow chart of one potential method of using 200 one potential embodiment of a powerline de-icing device 100 of the present invention while attached to a power line pole in accordance with the disclosed architecture. The device 100 is also comprised of a method 200 of using the device 100. First, the device 100 is secured to a power line pole 12 via the strap 190 and a fastener 192 [Step 202]. Then, the wire 154 is wrapped around the power line 10 of the power line pole 12 [Step 204]. Next, the wire 154 can be secured around the power line 10 via a strap 190 [Step 206]. In an embodiment of the device 100 with a repositionable solar panel 122, the solar panel 122 can be positioned in the optimal position to receive maximum sunlight [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “powerline de-icing device” and “device” are interchangeable and refer to the powerline de-icing device 100 of the present invention.

Notwithstanding the foregoing, the powerline de-icing device 100 of the present invention and its various components can be of any suitable size and configuration as is known in the art without affecting the overall concept of the invention, provided that they accomplish the above-stated objectives. One of ordinary skill in the art will appreciate that the size, configuration and material of the powerline de-icing device 100 as shown in the FIGS. are for illustrative purposes only, and that many other sizes and shapes of the powerline de-icing device 100 are well within the scope of the present disclosure. Although the dimensions of the powerline de-icing device 100 are important design parameters for user convenience, the powerline de-icing device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A powerline de-icing device comprising:
a body;
a solar panel;
a battery;
a heating element; and
a wire.

2. The powerline de-icing device of claim 1, wherein the solar panel provides a charge to the battery.

3. The powerline de-icing device of claim 2, wherein the battery provides power to the heating element.

4. The powerline de-icing device of claim 3, wherein the heating element heats the wire.

5. A powerline de-icing device comprising:
a body;
a first strap having an opening;
a second strap;
a fastener positioned on the second strap;
a battery;
a solar panel that provides a charge to the battery;
a heating element that receives a power from the battery; and
a wire.

6. The powerline de-icing device of claim 5, wherein the first strap is attached to the body.

7. The powerline de-icing device of claim 6, wherein the first strap can receive a fastener to secure the powerline de-icing device to a power line pole.

8. The powerline de-icing device of claim 5, wherein the heating element provides an electrical current through the wire.

9. The powerline de-icing device of claim 8, wherein the electrical current heats the wire.

10. The powerline de-icing device of claim 5, wherein the solar panel attaches to a top surface of the body via a mounting arm.

11. The powerline de-icing device of claim 10, wherein the solar panel is repositionable via a hinge point of the mounting arm.

12. The powerline de-icing device of claim 5, wherein the wire attaches to the heating element via a tab and a fastener.

13. The powerline de-icing device of claim 12, wherein a side surface of the body is comprised of an opening that allows the wire to attach to the heating element through the body.

14. The powerline de-icing device of claim 5, wherein the fastener of the second strap is a buckle, a tie, an elastic fastener or a zipper.

15. The powerline de-icing device of claim 5 further comprised of a temperature sensor.

16. The powerline de-icing device of claim 15, wherein the temperature sensor activates the heating element when an ambient temperature around the powerline de-icing device is below a threshold value.

17. The powerline de-icing device of claim 16, wherein the threshold value is 32 degrees Fahrenheit.

18. A method of using a powerline de-icing device comprising:
securing the powerline de-icing device to a power line pole via a strap and a fastener;
wrapping a wire of the powerline de-icing device around a power line of the power line pole; and
securing the wire around the power line via a strap.

19. The method of claim 18, wherein the powerline de-icing device is further comprised of a repositionable solar panel.

20. The method of claim 18 further comprised of a step of positioning the solar panel in an optimal position to receive a maximum amount of sunlight.
